(19) United States
(12) Patent Application Publication
(10) Pub. No.: US 2009/0156221 A1
(43) Pub. Date: Jun. 18, 2009

(54) Handover method and apparatus in mobile network

(75) Inventors: Jeong Suk Bae, Daejeon (KR); Gyung Chul Sihn, Daejeon (KR); Tae Hoon Kim, Daejeon (KR); Yong Hoon Choi, Daejeon (KR); Su Jung Kim, Daejeon (KR); Young Nam Han, Daejeon (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon (KR); RESEARCH AND INDUSTRIAL COOPERATION GROUP OF INFORMATION AND COMMUNICATIONS UNIVERSITY, Daejeon (KR)

(21) Appl. No.: 12/233,885

(22) Filed: Sep. 19, 2008

(30) Foreign Application Priority Data
Dec. 17, 2007 (KR) 10-2007-0132823

(51) Int. Cl. H04W 36/14; H04W 36/00

(52) U.S. Cl. 455/443; 455/436; 370/331

(57) ABSTRACT

A method and an apparatus for performing handover in a mobile communication network are provided. The method of performing handover in a mobile communication network includes: obtaining a service providing time period and a utility function on a candidate network basis; obtaining a selection function of each of the candidate networks using the utility function and the service providing time period; and selecting a network for handover among the plurality of mobile networks using the selection function. Therefore, in consideration of user satisfaction and a network service quality, utility functions are defined and by selecting a network for handover using the utility functions, a network suitable for a user environment can be effectively selected and thus it is possible to perform handover that has a performance and a cost suitable for user request and that can maximize a quality of a mobile service.

### BACKGROUND OF THE INVENTION

1. Field of the Invention

The present invention relates to a method and an apparatus for performing handover in a mobile communication network in which a mobile communication terminal positioned at a region in which two or more mobile communication networks are overlapped selects an optimum network service and provides the optimum network service to a user.

The present invention was partly supported by the IT R&D program of Ministry of Information and Communication (MIC) and Institute for Information Technology Advancement (IITA) [Project No.: 2006-S-003-02, Project Title: Research on service platform for the next generation mobile comm.].

2. Description of the Related Art

Nowadays, a mobile communication network has an overlay network structure having an overlapped service area due to mixing of a mobile access network for high-speed data communication, an existing wide-area cellular mobile access network, and a local area mobile access network.

In an overlay mobile communication network environment, in order to provide a ceaseless service to a user in an optimum network regardless of a user position, it is necessary to determine an optimum network among overlapped mobile communication networks and support handover for connecting to the optimum network.

### SUMMARY OF THE INVENTION

The present invention has been made in an effort to solve the above problems, and the present invention provides a method and an apparatus for performing handover that can provide an optimum mobile communication network suitable for a user environment and a requested service quality.

According to an aspect of the present invention there is provided a method of performing handover in a mobile communication network including: obtaining a utility function according to a use environment and user satisfaction of each of a plurality of candidate networks; obtaining a service providing time period of each of the plurality of candidate networks; obtaining a selection function of each of the plurality of candidate networks using the obtained utility function and mobile service providing time period; and selecting a network for handover among the plurality of candidate networks using the obtained selection function.

According to another aspect of the present invention, there is provided an apparatus for performing handover in a mobile communication network including: a first selection unit that selects at least one candidate network of a plurality of mobile networks to which a user terminal can be connected; a utility function configuration unit that obtains a utility function according to a use environment and user satisfaction of each of the candidate networks; a time calculation unit that obtains a service providing time period of each of the plurality of candidate networks; a selection function configuration unit that obtains a selection function of each of the plurality of candidate networks using the obtained utility function and service providing time period; and a second selection unit that selects a network for handover among the plurality of candidate networks using the obtained selection function.

According to another aspect of the present invention, there is provided a computer readable recording medium on which a program for executing the method in a computer is recorded.

### BRIEF DESCRIPTION OF THE DRAWING

FIG. 1 a diagram illustrating an exemplary embodiment of a configuration in which a plurality of mobile networks are overlapped;

FIG. 2 is a block diagram illustrating a configuration of an apparatus for performing handover according to an exemplary embodiment of the present invention;

FIG. 3 is a flowchart illustrating a method of performing handover in a mobile communication network according to an exemplary embodiment of the present invention; and

FIGS. 4 and 5 are graphs illustrating exemplary embodiments of a utility function.

### DETAILED DESCRIPTION OF THE PREFERRED EMBODIMENT

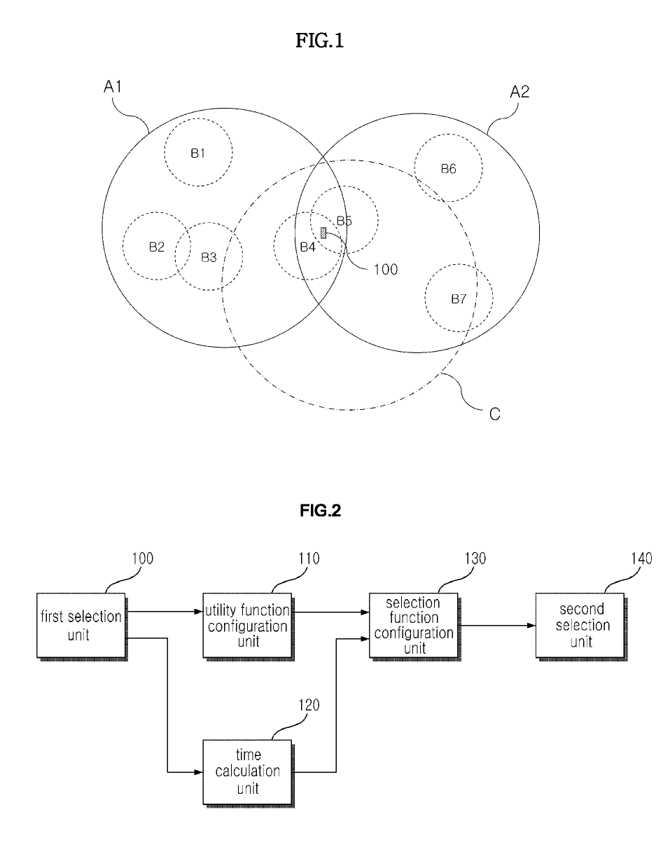

A method and an apparatus for performing handover in a mobile communication network according to an exemplary embodiment of the present invention will be described in detail hereinafter with reference to FIGS. 1 to 5.

FIG. 1 a diagram illustrating an exemplary embodiment of a configuration in which a plurality of mobile networks are overlapped.

Referring to FIG. 1, according to a position of a mobile network base station, a plurality of mobile networks may be overlapped.

That is, a plurality of mobile networks (A, B, and C) to which different mobile network technology is applied may be overlapped, and a plurality of mobile network cells belonging to one mobile network may be overlapped.

For example, as shown in FIG. 1, as 2 base stations for providing a mobile network A are positioned, a mobile network cell A1 and a mobile network cell A2 for providing the mobile network A may exist. Further, as 7 base stations for providing a mobile network B are positioned, 7 mobile network cells (B1, B2, B3, B4, B5, B6, and B7) for providing the mobile network A may exist. Further, as one base station for providing a mobile network C is positioned, a mobile network cell C for providing the mobile network C may exist.

The plurality of mobile networks may be a mobile communication network for high speed data transmission, a wide-area cellular network, and a local area mobile network (WLAN).

Referring to FIG. 1, in an area at which the mobile communication terminal 100 is positioned, a mobile network cell A1, a mobile network cell A1, a mobile network cell B4, a mobile network cell B5, and a mobile network cell C may be overlapped and connected.

FIG. 2 is a block diagram illustrating a configuration of an apparatus for performing handover according to an exemplary embodiment of the present invention, and the apparatus for performing handover includes a first selection unit 100, a utility function configuration unit 110, a time calculation unit 120, a selection function configuration unit 130, and a second selection unit 140.

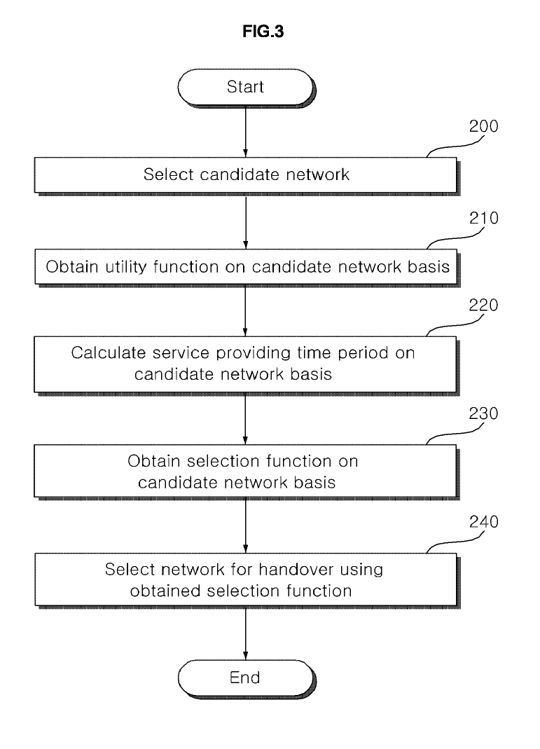

An operation of the apparatus for performing handover shown in FIG. 2 is described using a flowchart illustrating a method of performing handover according to an exemplary embodiment of the present invention shown in FIG. 3.

The first selection unit 100 selects candidate networks satisfying a condition to be a network for handover among a plurality of mobile networks that can be connected by a user terminal (S200).

That is, the first selection unit 100 can previously remove networks that do not satisfy a minimum condition requested by a user among a plurality of mobile networks for handover of the user terminal and thus because the quantity of candidate networks decreases, an operation amount for performing handover can be reduced.

For example, the first selection unit 100 sets a minimum signal-to-noise ratio (SNR) level requested for providing a service, a maximum handover delay that can be allowed by the user, or the minimum quantity of sub-channels for providing a service as a reference condition and removes mobile networks that do not satisfy the reference condition from a candidate network.

Equation 1 is an example of a function using for selecting the candidate network.

E=U(SNRⱼⁱ−SNRᵢ_{_{—}}ₜₕᵣ)·U(T_{Max}_{_{—}}_{allowed}_{_{—}}_{HQ}_{_{—}}_{delay}−T_{HO}_{_{—}}_{delay}^{j})·U(Nⱼⁱ−Nⱼ_{_{—}}_{required}ⁱ) [Equation 1]

Equation 1 represents a function for determining whether a j-th mobile network may be a candidate network in providing an i-th mobile service. If the E is 1, the j-th mobile network can become a candidate network, and if the E is 0, the j-th mobile network cannot become a candidate network.

In Equation 1, the SNRij is a SNR when providing the i-th mobile service using the j-th mobile network and the SNRi_thr is a minimum SNR required for providing an i-th mobile service. Further, the TiMax_allowed_HO₁₃ delay is an allowable maximum handover delay when the user uses the i-th mobile service, and the TjHO_delay is a handover delay generating when performing handover to the j-th mobile network. Further, the Nij is the quantity of available service channels when providing the i-th mobile service using the j-th mobile network and the Nij_required is the minimum quantity of sub-channels for providing the i-th mobile service using the j-th mobile network.

In Equation 1, the U( ) may be a unit step function and thus a mobile network that does not satisfy the reference values (SNRi, TiMax_allowed_HO_delay, and Nij_required) is removed from the candidate networks.

That is, the SNRi_thr is a minimum SNR that can satisfy a service quality (QoS) required on a service basis, and when a SNR provided by a mobile network is smaller than SNRi_thr for the corresponding service, the E becomes 0 and thus the mobile network is removed from the candidate networks for handover.

Further, the TiMax_allowed_HO_delay may be an allowable maximum handover delay on a service basis and when the mobile network becomes a candidate network for handover, if a delay consumed for handover is greater than TiMax_allowed_HO_delay, the E becomes 0 and thus the mobile network is removed from candidate networks for handover.

In a network using Orthogonal Frequency Division Multiple Access (OFDMA), the quantity of available sub-channels is estimated and is used as the Nij_required.

For example, when the i-th mobile service is used through the j-th mobile network, the Nij may be the quantity of sub-channels that can be provided to the user and the Nij value may be different according to a scheduling policy on a network basis and the quantity of users who receive the corresponding service on a service basis.

The minimum quantity of sub-channels on a service basis is obtained by Equation 2.

$${\overline{N}}_{required\_subchannel}^{i} = ⌈ \frac{{\overline{R}}_{required}^{i}}{{\overline{R}}_{subchannel}} ⌉ \\ {\overline{R}}_{required}^{i} = \frac{{\overline{R}}_{required ( bps )}^{i}}{{T}_{Frame}} \qquad [ Equation 2 ]$$

The N̅_{required}_{_{—}}_{subchannel}ⁱ is the minimum quantity of sub-channels required for a user who uses the i-th mobile service, the R̅_{required}ⁱ is an average data rate required for providing the i-th mobile service, and the TFrame is a time period of a unit frame. Further, the R̅_{subchannel} is a maximum data transmission speed per sub-channel that can be provided by a network system and may be different according to a capacity of the network system.

The utility function configuration unit 110 collects information about a user and a network and obtains a utility function in which a use environment of a network, user satisfaction are considered based on the collected information for each of the plurality of candidate networks (S210).

For example, the utility function configuration unit 110 can obtain the utility function based on an available data rate.

A real time data transmission service, for example a voice application is a mobile service conclusively affected by whether a service is provided according to acquisition of a data rate.

That is, in a system for transmitting real time data such as a general phone call or voice communication, a data rate more than a reference value should be always secured in order to provide a service.

Therefore, a utility function of a real time data transmission service such as a voice application is represented by Equation 3.

$$U ( c ) = \{ \begin{matrix}0 & for c < C min \\ 1 & otherwise\end{matrix} \qquad [ Equation 3 ]$$

In Equation 3, the c is a data rate that can be provided in the corresponding network, and the Cmin is a minimum data rate necessary for providing the corresponding service.

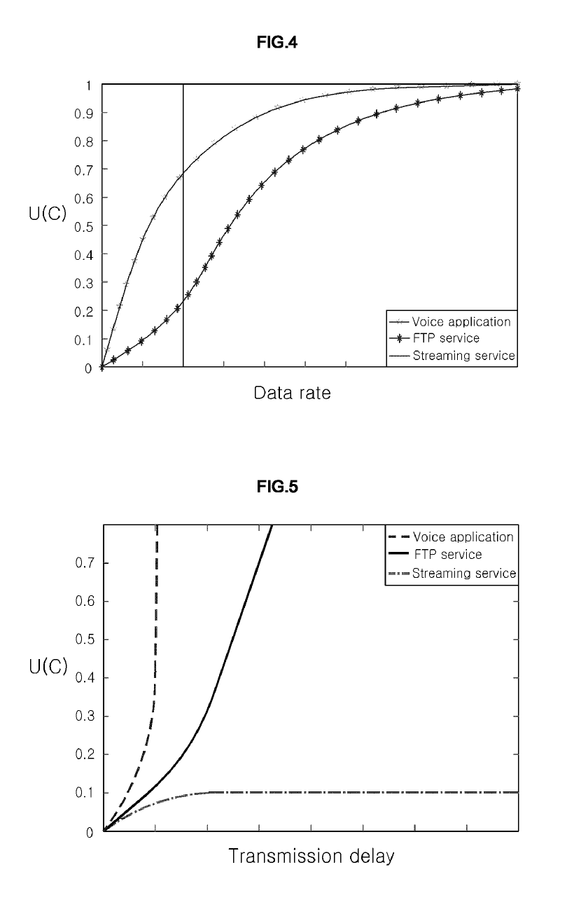

As shown in FIG. 4, a utility function of a real time data transmission service such as a voice application may have a form of a linear function and thus a mobile network that provides a data rate lower than a minimum data rate cannot become a network for handover by the utility function (U (C)).

Non-real time data transmission services such as File Transfer Protocol (FTP), web browsing, telnet, or e-mail do not always require a data rate more than a reference value.

Therefore, a utility function of a non-real time data transmission service such as FTP is represented by Equation 4.

$$U ( c ) = 1 - {e}^{\frac{- {α}_{e} c}{{C}_{max}}} \qquad [ Equation 4 ]$$

In Equation 4, the e is a constant for determining a gradient of a utility function and the Cmax is the maximum data rate in which the corresponding service can use.

In FIG. 4, it is assumed that the e value is 5 and the Cmax value is 5 Mbps, and a utility function of Equation 4 is represented by a graph.

As shown in FIG. 4, a utility function of a non-real time data transmission service such as FTP may have a form of strictly concave function.

Further, a streaming service is a real time data transmission service such as the voice application but has an intermediate characteristic of the voice application and the FTP service.

For example, in a delay-adaptive application such as an audio/video streaming service as a kind of a streaming service, even if data are transmitted with a value over a delay bound allowed within a system, data are not greatly influenced.

Further, in a rate-adaptive application such as a multimedia rate adaptive application, in order to prevent the change of a data capacity according to a network state, a traffic amount can be adjusted.

However, even in the streaming service, because a minimum data rate should be guaranteed, a utility function of the streaming service is represented by Equation 5.

$$U ( c ) = 1 - {e}^{- \frac{{c}^{2}}{k + c}} \qquad [ Equation 5 ]$$

In Equation 5, the c is an available data rate in the corresponding network and the k is a constant value indicating an inflection point of the utility function.

In FIG. 4, the k value is assumed to 2 and a utility function of Equation 5 is represented by a graph.

As shown in FIG. 4, a utility function graph of a streaming service includes both a concave form and a convex form, and the inflection point k is positioned between two forms.

Therefore, as the k increases, a convex portion increases in the utility function graph of a streaming service and as the k decreases, a concave portion increases in the utility function graph of a streaming service.

Further, the utility function configuration unit 110 can obtain the utility function based on a transmission delay.

A network environment such as a bit error rate (BER), a delay, and a SNR requested by the user may be different according to a type of a mobile service used by the user. Particularly, sensitivity about a transmission delay shows a remarkable difference between real time transmission and non-real time transmission.

Therefore, the utility function configuration unit 110 can form a utility function using a transmission delay as a parameter for representing user satisfaction.

For example, in a real time data transmission service such as a voice application or a streaming service, user dissatisfaction rapidly rises according to the increase of an average transmission delay, compared with a non-real time data transmission service such as FTP.

Therefore, a utility function of a real time data transmission service such as a voice application or a streaming service is represented by Equation 6.

U(D)=e^{βd} [Equation 6]

In Equation 6, the d is an average transmission delay of the corresponding network and the b is a constant indicating a rising rate of user dissatisfaction according to the increase of an average transmission delay.

By changing the b, a utility function of a voice application and a utility function of a streaming service can be distinguished and as shown in FIG. 5, a value b of a utility function of a voice application may be greater than a value b of a utility function of a streaming service.

Accordingly, according to the increase of an average transmission delay, the utility function can be formed so that dissatisfaction of a voice application user rises more rapidly than that of a streaming service user.

A utility function of a non-real time data transmission service such as FTP is represented by Equation 7.

U(D)=λ log(γd) [Equation 7]

In Equation 7, the d is an average transmission delay of the corresponding network, the g is a parameter representing user dissatisfaction adjacent to a point 0, and ‘1’ is a parameter representing a maximum value of user dissatisfaction.

In FIG. 5, the 1 is assumed to 0.1 and the g is assumed to 10, and a utility function of a non-real time data transmission service represented in Equation 7 is represented by a graph.

Further, the utility function configuration unit 110 can form a utility function including a utility function (U(C)) based on an available data rate and a utility function (U(D)) based on the transmission delay, as described above.

For example, a utility function TU finally obtained in the utility function configuration unit 110 can be formed using the sum of a utility functions (U(C)) based on an available data rate and a utility function (U(D)) based on a transmission delay, as in Equation 8.

TU=η·U(C)−(1−η)·U(D) [Equation 8]

In Equation 8, the η is a constant representing a weight between two utility functions (U(C), U(D)).

That is, when selecting a network for handover, in order to set a weight to a data rate provided by the network, the η is increased, and in order to set a weight to a transmission delay, the η is decreased.

As described above, when at least one of the obtained utility function (TU) values of each network has a negative value, by correcting the utility function (TU) values to a positive value or by removing networks in which the utility function (TU) value is a negative value from a candidate group of networks for handover, utility function (TU) values of networks that can be selected as a network for handover can have a positive value.

The time calculation unit 120 calculates a service providing time period Tservice_time, which is a time period in which the corresponding service is actually provided using each of the plurality of candidate networks (S220).

That is, the service providing time period Tservice_time is a time period from a time point performing handover to the corresponding network to a time point in which handover is completed from the corresponding network to other network.

For example, when handover to an i-th network different from a currently connected network i.e. vertical handover is performed, the service providing time period Tservice_time can be obtained using the minimum value among a time period Ticell_residence in which a user terminal actually stays in the second network area as the user terminal is positioned within an area that can be connected to the second network and a time period Tservice_completion consumed in order to complete the corresponding service.

In this case, the Ticell_residence may be estimated based on a moving path of the user terminal and a moving speed, and the Tservice completion may be estimated based on the remaining data amount and a data rate provided by the corresponding network.

Equation 9 is an example of a method of calculating the service providing time period Tservice_time when handover is performed.

T_{service}_{_{—}}ₜᵢₘₑⁱ=Min(T_{cell}_{_{—}}_{residence}ⁱ, T_{Service}_{_{—}}_{completion})+v·T_{HHO}_{_{—}}_{delay}⁰ [Equation 9]

In Equation 9, the T0HHO_delay is a handover delay generating when performing handover in the same kind of network i.e. horizontal handover using the same mobile network technology and the γ is a constant to be determined according to positions of a network to which a user terminal is currently connecting and a network for handover.

Even when the user terminal continues to connect to the same kind of network, because horizontal handover is performed between the same kind of networks, a handover delay may occur. Accordingly, in the T0HHO_delay, a delay according to the horizontal handover is reflected to the service providing time period Tservice_time.

However, when continuing to connect to the same kind of network, because the horizontal handover is not always performed, in a serving sell handover area in which horizontal handover can be performed among an estimate moving path of the user terminal, by setting the γ to 1, the horizontal handover delay is reflected to the service providing time period Tservice_time and in other areas, the γ is set to 0.

Further, when the user terminal continues to connect to the currently connected network and handover to a different kind of network is not performed, the service providing time period Tservice_time is calculated by Equation 10.

T_{service}_{_{—}}ₜᵢₘₑⁱ=Min(T_{cell}_{_{—}}_{residence}ⁱ, T_{Service}_{_{—}}_{completion})+2·T_{VHO}_{_{—}}_{delay}ⁱ [Equation 10]

In Equation 10, the TiVHO_delay is a delay due to vertical handover to the different kind of network.

When entering the different kind of network and separating from the different kind of network, because a handover delay of 2 times occurs, by multiplying 2 to the TiVHO_delay and then adding the obtained value to the minimum value, the service providing time period Tservice_time can be calculated.

This is because when the user terminal stays the current network, a time period that can transmit data can increase by a delay (2·TiVHO_delay) due to handover, compared with when performing handover.

The selection function configuration unit 130 obtains a selection function NSF for selecting a network for handover using a utility function on a candidate network basis obtained at step 210 and a service providing time period on a candidate network basis calculated at step 220 (S230).

For example, the selection function NSF is represented by Equation 11.

NSFᵢ=TUᵢ(·)·Tⁱ_{service}_{_{—}}ₜᵢₘₑ [Equation 11]

In Equation 11, the TUi(·) is a utility function obtained for an i-th network at step 210 and the Tiservice_time is a service providing time period obtained for the i-th network at step 220.

The second selection unit 140 selects a network for handover among a plurality of candidate networks using the obtained selection function (S240).

In a selection function NSFi represented by Equation 11, a network in which a result value of the selection function NSFi is greatest can be selected as a network for handover.

In a method of performing handover according to the present invention, in consideration of user satisfaction and a network service quality, utility functions are defined and by selecting a network for handover using the utility functions, a network suitable for a user environment can be effectively selected and thus it is possible to perform handover that has a performance and a cost suitable for user request and that can maximize a quality of a mobile service.

The present invention may be also implemented with computer readable codes in a computer readable recording medium. The computer readable recording medium may include all kinds of recording devices in which data that can be read by a computer system are stored. The computer readable recording medium may include, for example a ROM, a RAM, a CD-ROM, a magnetic tape, a floppy disk, and an optical data storage device. In addition, the computer readable recording medium may also include implementations in the form of carrier waves (e.g. transmission via Internet). Further, the computer readable recording medium is distributed to a computer system connected to a network and the computer readable codes may be stored and executed therein in a distributed manner.

The embodiment of the invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method of performing handover in a mobile communication network, comprising;
obtaining a utility function according to a use environment and user satisfaction of each of a plurality of mobile networks;
obtaining a service providing time period of each of the plurality of mobile networks;
obtaining a selection function of each of the plurality of mobile networks using the obtained utility function and service providing time period; and
selecting a network for handover among the plurality of mobile networks using the obtained selection function.

2. The method of claim 1, further comprising:
selecting the plurality of mobile networks among networks to which a user terminal can be connected using at least one of a reference signal-to-noise ratio (SNR), a reference handover delay, and the reference quantity of sub-channels.

3. The method of claim 1, wherein the utility function comprises a first utility function according to a data ratio of the mobile network and a second utility function according to a transmission delay of the mobile network.

4. The method of claim 3, wherein the first utility function is a linear function, when a service provided by the mobile network is a real time data transmission service.

5. The method of claim 3, wherein the first utility function is a strictly concave function, when a service provided by the mobile network is a non-real time data transmission service.

6. The method of claim 3, wherein the first utility function is a non-linear function having an inflection point, when a service provided by the mobile network is a data streaming service.

7. The method of claim 3, wherein the second utility function is an exponential function that includes the transmission delay as an exponent, when a service provided by the mobile network is a real time data transmission service

8. The method of claim 3, wherein the second utility function is a logarithmic function that includes the transmission delay as an antilogarithm, when a service provided by the mobile network is a non-real time data transmission service.

9. The method of claim 1, wherein the service providing time period of the mobile network is calculated using a minimum value among a time period in which a user terminal is positioned within a connectable area of the mobile network and a time period necessary for completing the service in a state connected to the mobile network.

10. The method of claim 9, wherein the service providing time period of the mobile network is calculated by the sum of the minimum value and a delay according to vertical handover, when the mobile network is a network to which the user terminal is currently connected.

11. The method of claim 9, wherein the service providing time period of the mobile network is calculated by the sum of the minimum value and a delay according to horizontal handover, when the mobile network is different from a network to which the user terminal is currently connected.

12. The method of claim 1, wherein the selection function is obtained using multiplication of a utility function of the mobile network and a service providing time period.

13. The method of claim 12, wherein the selecting of a network for handover comprises selecting a mobile network in which a result value of the selection function is greatest among the plurality of mobile networks as the network for handover.

14. The method of claim 1, wherein the method of performing handover is performed in each of a plurality of mobile services.

15. An apparatus for performing handover in a mobile communication network, comprising:
a first selection unit that selects at least one candidate network of a plurality of mobile networks to which a user terminal can be connected;
a utility function configuration unit that obtains a utility function according to a use environment and user satisfaction of each of the candidate networks;
a time calculation unit that obtains a service providing time period of each of the plurality of candidate networks;
a selection function configuration unit that obtains a selection function of each of the plurality of candidate networks using the obtained utility function and service providing time period; and
a second selection unit that selects a network for handover among the plurality of candidate networks using the obtained selection function.

16. The apparatus of claim 15, wherein the first selection unit selects at least one candidate network of a connectable plurality of mobile networks using at least one of a reference SNR, a reference handover delay, and the reference quantity of sub-channels.

17. The apparatus of claim 15, wherein the utility function comprises a first utility function according to a data ratio of the candidate network and a second utility function according to a transmission delay of the candidate network.

18. The apparatus of claim 15, wherein the service providing time period of the candidate network is calculated using a minimum value among a time period at which a user terminal is positioned within a connectable area of the candidate network and a time period necessary for completing the service in a state connected to the candidate network.

19. The apparatus of claim 15, wherein the selection function is obtained using multiplication of a utility function of the candidate network and a service providing time period.
